(19) United States
(12) Patent Application Publication
(10) Pub. No.: US 2009/0154661 A1
(43) Pub. Date: Jun. 18, 2009

(54) VOICE MAIL APPARATUS AND CONTROL METHOD OF VOICE MAIL APPARATUS

(75) Inventors: Noriaki Ikeda, Hachioji-shi (JP); Nobuhiro Masaki, Kodaira-shi (JP); Akira Takahashi, Tokorozawa-shi (JP); Norikuni Noguchi, Mitaka-shi (JP); Kazuharu Horiuchi, Tachikawa-shi (JP); Hiroki Ida, Ome-shi (JP); Norimasa Niiya, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/256,286

(22) Filed: Oct. 22, 2008

(30) Foreign Application Priority Data
Dec. 18, 2007 (JP) 2007-326236

(51) Int. Cl. H04M 1/64

(52) U.S. Cl. 379/88.08

(57) ABSTRACT

According to one embodiment, a voice mail apparatus includes a first determining module which determines whether a dual tone multi frequency (DTMF) signal for identifying a processing request of the voice message is contained in a received signal by detecting and comparing a first parameter of a transmission signal from the mail box and the first parameter of the received signal to the mail box, a second determining module which determines whether the DTMF signal is contained in the received signal by detecting and comparing a second parameter of the transmission signal from the mail box and the second parameter of the received signal to the mail box, and a controller which controls execution/stop of processing of the voice message based on a determination result by the second determining module.

### CROSS-REFERENCE TO RELATED APPLICATIONS

This application is based upon and claims the benefit of priority from Japanese Patent Application No. 2007-326236, filed Dec. 18, 2007, the entire contents of which are incorporated herein by reference.

### BACKGROUND

1. Field

One embodiment of the present invention relates to a voice mail apparatus that records a voice message from a calling party in a mail box or reproduces a voice message from the mail box and a method of controlling the voice mail apparatus.

2. Description of the Related Art

In office buildings and business places, for example, telephone exchange apparatuses such as PBX (private branch exchange) and key telephone apparatuses have frequently been used. A voice mail apparatus is connected to such a telephone exchange apparatus and has a function, for example, to transfer an incoming call arriving at an extension from an outside line to the voice mail unit when the extension housed in the telephone exchange apparatus is busy or not responding because the seat is left.

The voice mail apparatus has a function, for example, to store messages from telephones in a mail box.

Incidentally, if a voice message recorded in the mail box should be heard in the above system, a user of a telephone set housed in the telephone exchange apparatus sends out a reproduction request including a dual tone multi frequency (DTMF) signal by a dial operation and the voice mail apparatus enables reproduction of the voice message in the mail box after detecting the DTMF signal. When the DTMF signal is detected, it is necessary to prevent detection of echo back as a DTMF signal.

A technology to prevent erroneous detection by determining whether or not received voice data is echo back by sampling the received voice data at intervals of 10 ms after providing a DTMF receiver in the voice mail unit has been proposed (for example, Jpn. Pat. Appln. KOKAI Publication No. 2005-252768).

Apart from the above technology, a technique capable of detecting only genuine DTMF signals in the voice mail apparatus without needing complicated processing is urgently demanded. However, such a technique is still in a stage of consideration and is not currently realized.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the configuration of an exchange system according to an embodiment of the present invention;

FIG. 2 is a block diagram showing the connection configuration between a voice mail apparatus shown in FIG. 1 and an extension terminal;

FIG. 3A is a diagram illustrating a waveform sent out from a mail box and that echoed back to the mail box;

FIG. 3B is a diagram illustrating a waveform sent out from a mail box and that echoed back to the mail box;

FIG. 4A is a diagram illustrating a signal waveform received by a DSP when a stored voice receiver sends out a DTMF signal;

FIG. 4B is a diagram illustrating a signal waveform received by a DSP when a stored voice receiver sends out a DTMF signal;

FIG. 5 is a flow chart showing a processing procedure of the DSP for DTMF detection in the embodiment;

FIG. 6 is a diagram illustrating an input waveform recorded in a sending DTMF receiver in the embodiment;

FIG. 7 is a diagram illustrating an example of the waveform echoed back in the embodiment;

FIG. 8 is a diagram illustrating another example of the waveform echoed back in the embodiment;

FIG. 9A is a diagram illustrating the signal waveform received by the DSP when the stored voice receiver sends out a DTMF signal in the embodiment;

FIG. 9B is a diagram illustrating the signal waveform received by the DSP when the stored voice receiver sends out a DTMF signal in the embodiment; and

FIG. 9C is a diagram illustrating the signal waveform received by the DSP when the stored voice receiver sends out a DTMF signal in the embodiment.

### DETAILED DESCRIPTION

Various embodiments according to the invention will be described hereinafter with reference to the accompanying drawings. In general, according to one embodiment of the invention, a voice mail apparatus connected to a telephone exchange apparatus performing exchange processing among a plurality of telephone terminals to record a voice message sent out from the telephone terminal on a calling side in response to a termination call from the telephone exchange apparatus in a mail box and to reproduce the voice message recorded in the mail box in accordance with reproduction instructions, comprising: a first determining module which determines whether a dual tone multi frequency (DTMF) signal for identifying a processing request of the voice message is contained in a received signal by detecting and comparing a first parameter of a transmission signal from the mail box and the first parameter of the received signal to the mail box; a second determining module which determines whether the DTMF signal is contained in the received signal by detecting and comparing a second parameter being different from the first parameter of the transmission signal from the mail box and the second parameter of the received signal to the mail box, when the DTMF signal is not contained in the received signal from a determination result by the first determining module; and a controller which controls execution/stop of processing of the voice message based on a determination result by the second determining module.

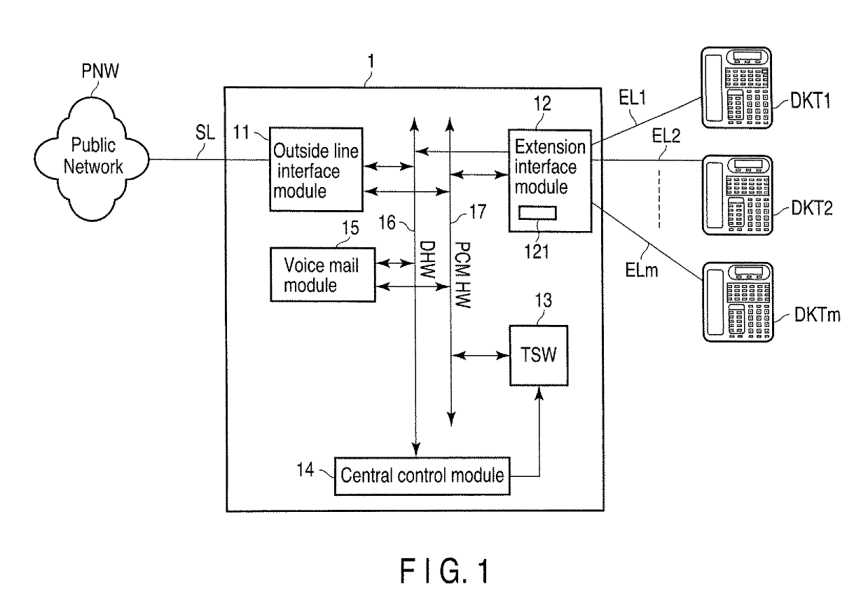

FIG. 1 is a block diagram showing the configuration of an exchange system according to the embodiment of the present invention and reference numeral 1 shows a main apparatus.

The main apparatus 1 includes an outside line interface module 11, an extension interface module 12, a time switch 13, a central control module 14, and a voice mail module 15 and, among these modules, the outside line interface module 11, the extension interface module 12, the central control module 14, and the voice mail module 15 are mutually connected via a control bus (DHW) 16. Moreover, the outside line interface module 11, the extension interface module 12, the time switch 13, and the voice mail module 15 are mutually connected via a voice bus (PCMHW) 17.

The outside line interface module 11 is connected to a public network PNW via a subscriber line SL to perform processing to establish call connection with the public network PNW.

A plurality of extensions EL1 to ELm (m is a natural number) are contained in the extension interface module 12 and extension terminals DKT1 to DKTm are connected to the extensions EL1 to ELm, respectively. Digital key telephone sets, for example, are used as the extension terminals DKT1 to DKTm. The extension interface module 12 performs call originating and terminating processing for the extension terminals DKT1 to DKTm, transfer processing of digital signals and the like. The extension interface module 12 is also provided with a CO module 121 including a two-wire/four-wire conversion function.

The time switch 13 changes channels of digital signals transmitted among the outside line interface module 11, the extension interface module 12, and the voice mail module 15 according to instructions of the central control module 14 via the voice bus 17.

The central control module 14 includes a terminating response control function using the voice mail module 15, in addition to normal control functions such as call originating processing accompanying a call request from the extension terminals DKT1 to DKTm, normal call terminating processing accompanying an incoming call from the subscriber line 5L, and transfer processing among the extension terminals DKT1 to DKTm. The terminating response control function is a function that, when an incoming call arrives, connects the voice mail module 15 and the originator by making a termination call to the voice mail module 15 before making a termination call to the destination extension terminal DKT1, thereby performing control to have a predetermined announcement message sent out to the originator.

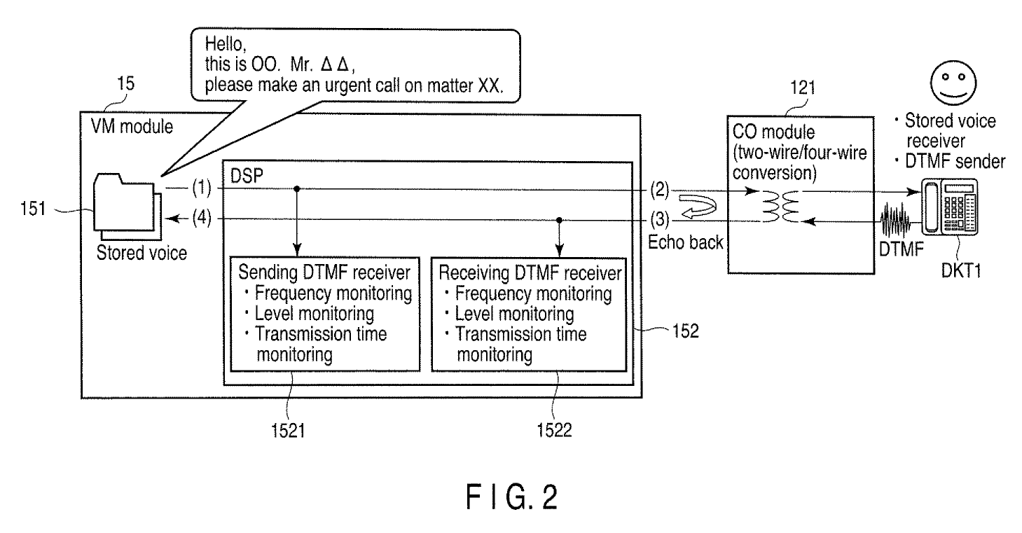

As shown in FIG. 2, the voice mail module 15 includes a mail box 151 corresponding to each of the extension terminals DKT1 to DKTm and a voice message from the originator “Hello, this is OO. Please make an urgent call to . . . ” is stored in the mail box 151.

Incidentally, the voice mail module 15 in the present embodiment is provided with a digital signal processor (DSP) 152. The DSP 152 is provided with a sending DTMF receiver 1521 and a receiving DTMF receiver 1522. The sending DTMF receiver 1521 monitors a signal sent out from the mail box 151 in the order of frequency monitoring, signal level monitoring, and transmission time monitoring. The receiving DTMF receiver 1522 monitors a signal to the mail box 151 in the order of frequency monitoring, signal level monitoring, and transmission time monitoring.

Then, the DSP 152 determines whether a DTMF signal is contained by comparing a monitoring result of the sending DTMF receiver 1521 and that of the receiving DTMF receiver 1522. If a DTMF signal is contained and the DTMF signal is a reproduction request of a voice message to the mail box 151, the DSP 152 reproduces the voice message from the mail box 151. If the DTMF signal is a stop request of a voice message to the mail box 151, the DSP 152 stops the voice message sent out from the mail box 151.

Next, operations in the above configuration will be described.

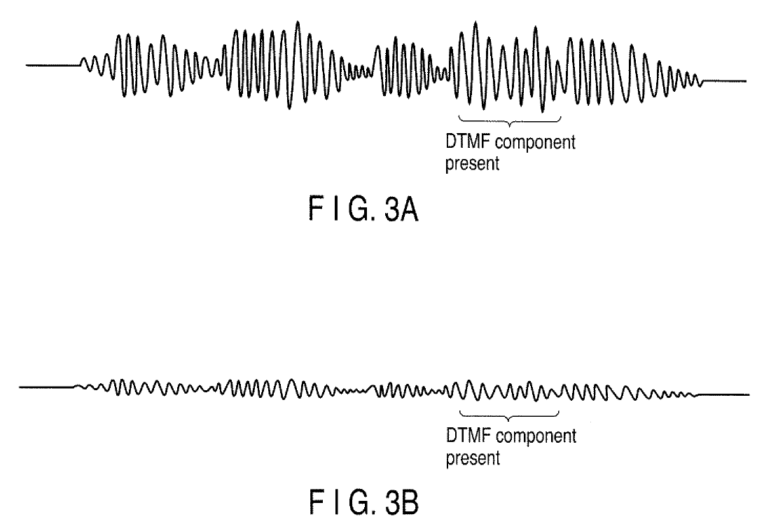

When a voice waveform shown in FIG. 3A is sent out from the mail box 151, the DSP 152 records DTMF components in the sending DTMF receiver 1521 and sends out the voice waveform to the requesting extension terminal DKT1. The voice waveform is caused to flow backward by two-wire/four-wire conversion of the CO unit 121, returning to the voice mail box 151 in a waveform shown in FIG. 3B.

The DSP 152 records the return waveform in the receiving DTMF receiver 1522, compares components by (1) and (3) in FIG. 2, and determines that the return waveform is echo back, so that DTMF detection is not performed.

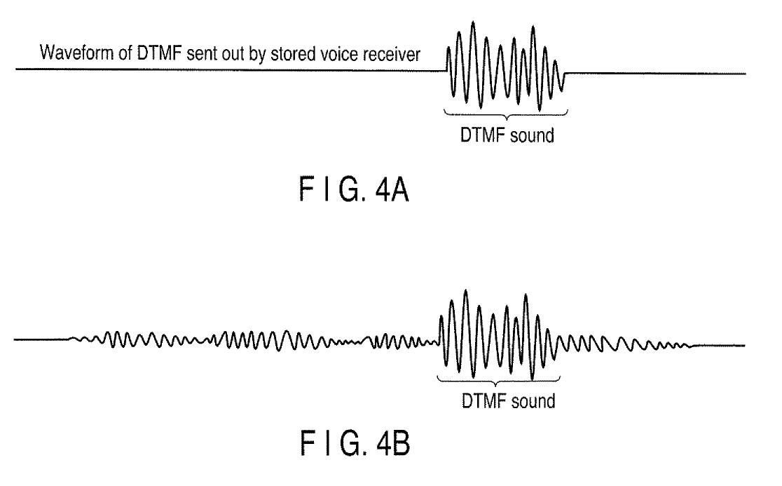

Even if a DTMF delivery waveform shown in FIG. 4A is sent out by a dial operation of the user of the extension terminal DKT1, a waveform obtained by synthesizing voice flow-back caused by two-wire/four-wire conversion of the CO module 121 and DTMF of the same frequency from a stored voice receiver results, as shown in FIG. 4B, so that genuine DTMF is not detected after being determined by the DSP 152 to be echo back (unexpected non-detection of DTMF may occur).

Thus, in the present embodiment, non-detection of genuine DTMF signals can be prevented by monitoring frequencies, signal levels, and transmission times using the sending DTMF receiver 1521 and the receiving DTMF receiver 1522.

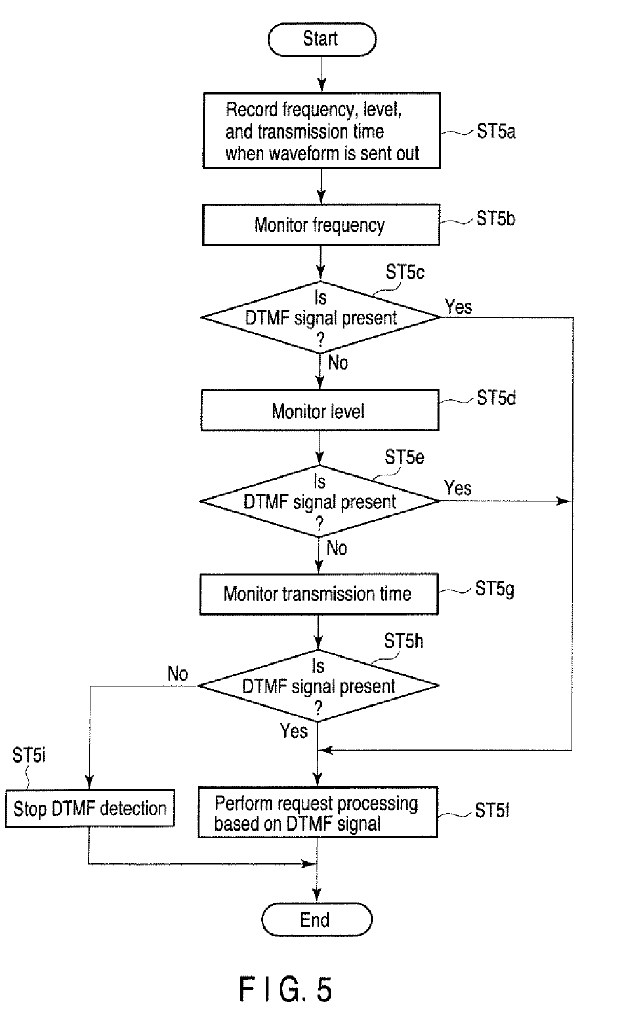

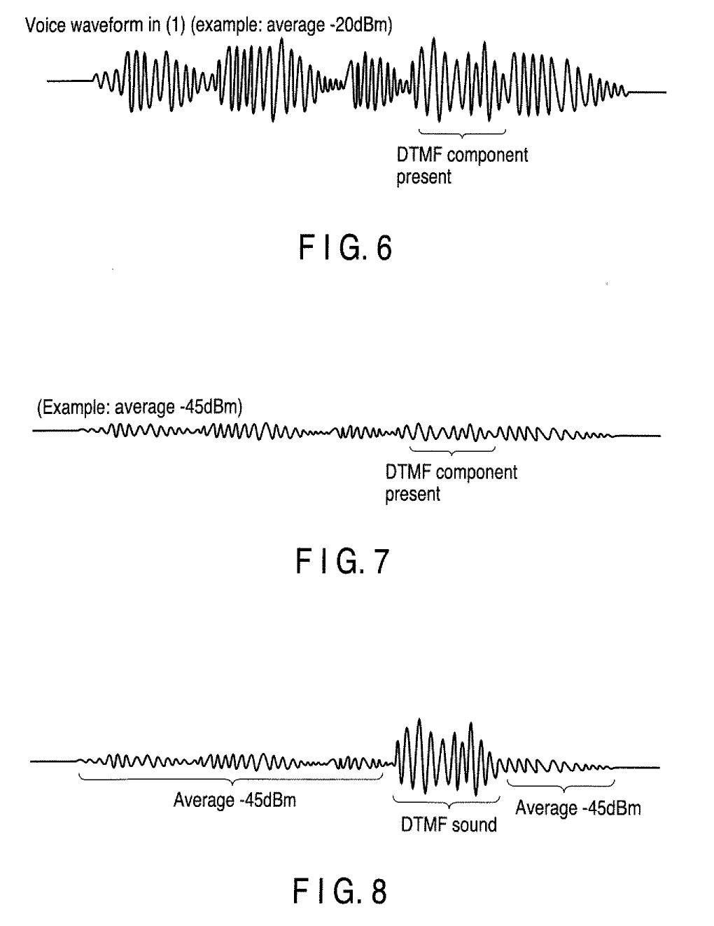

FIG. 5 is a flow chart showing a processing procedure of the DSP 152 for DTMF detection. First, the DSP 152 records the frequency, signal level, and transmission time during input shown in FIG. 6 using the sending DTMF receiver 1521 and outputs a waveform to the requesting extension terminal DKT1 (block ST5a).

The output waveform is caused to flow backward by two-wire/four-wire conversion of the CO module 121, returning to the DSP 152 in a waveform attenuated to the level shown in FIG. 7. The DSP 152 detects this waveform using the receiving DTMF receiver 1522 and compares the frequency thereof with that recorded in the sending DTMF receiver 1521 (block ST5b). Here, if, as shown in FIG. 8, a voice waveform is determined to be echo back by recognizing that only the level thereof is uniformly attenuated, the DSP 152 transits from block ST5c to block ST5d and compares the signal level recorded in the sending DTMF receiver 1521 and that recorded in the receiving DTMF receiver 1522 to determine whether a DTMF signal is contained (block ST5e).

Here, if determined that a DTMF signal is contained (Yes), the DSP 152 performs request processing based on the DTMF signal to the mail box 151 (block ST5f).

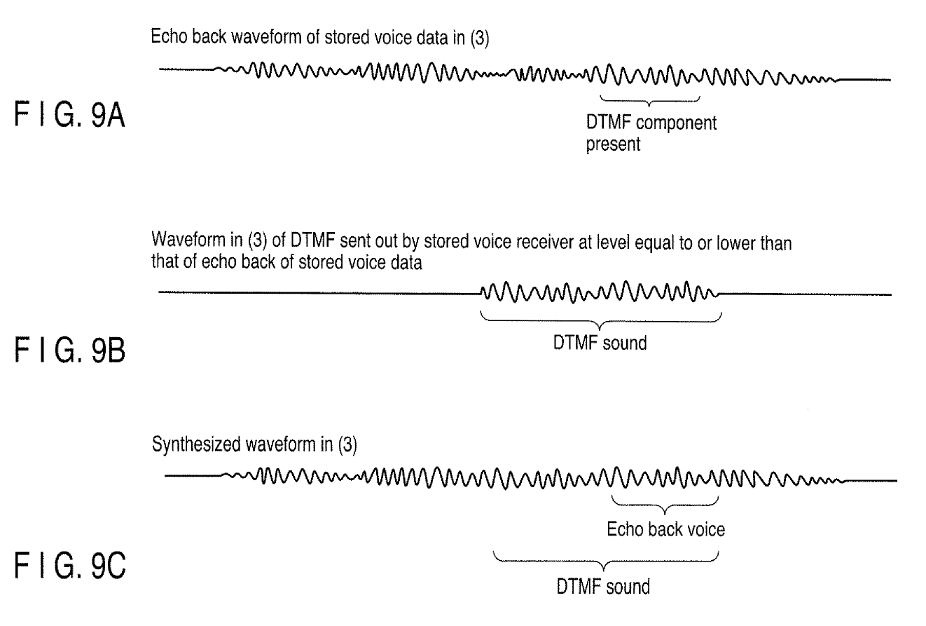

If, on the other hand, the user of the requesting extension terminal DKT1 sends out a genuine DTMF signal (delivery time difference), the echo-back waveform of stored voice data (voice message) by the CO module 121 will look like a waveform shown in FIG. 9A and, if the user of the requesting extension terminal DKT1 sends out a DTMF signal at a level equal to or lower than that of echo back of the stored voice data, a waveform returned by the CO module 121 will look like a waveform shown in FIG. 9B. Thus, the synthesized waveform will look like a waveform shown in FIG. 9C.

Hence, the DSP 152 compares the transmission time recorded in the sending DTMF receiver 1521 and that recorded in the receiving DTMF receiver 1522 (block ST5g) to determine whether a DTMF signal is contained (block ST5h).

Here, if determined that a DTMF signal is contained (Yes), the DSP 152 performs request processing based on the DTMF signal to the mail box 151 and if determined that a DTMF signal is not contained (No), the DSP 152 stops DTMF detection processing (block ST5i).

If determined at block ST5c that a DTMF signal is contained, the DSP 152 transits to block ST5f to perform request processing based on the DTMF signal to the mail box 151.

In the present embodiment, as described above, the DSP 152 first records the frequency, signal level, and transmission time of a transmission waveform from the mail box 151 in the sending DTMF receiver 1521, receives a waveform echoed back by the CO module 121 using the receiving DTMF receiver 1522, and determines whether a DTMF signal from the requesting extension terminal DKT1 is contained by comparing the frequency of the received waveform and that of the waveform recorded in the sending DTMF receiver 1521. If determined to be echo back, the DSP 152 compares the signal level of the received waveform and that of the waveform recorded in the sending DTMF receiver 1521 without terminating DTMF detection processing, and if further determined to be echo back, determines whether a DTMF signal from the requesting extension terminal DKT1 is contained by comparing the transmission times.

Therefore, a DTMF signal can be detected by the DSP 152 with high precision, thereby increasing reliability of DTMF signal detection processing. Moreover, a processing load on the DSP 152 needed to detect a DTMF signal can be reduced.

Incidentally, the present invention is not limited to the above embodiment. For example, an example in which the frequency, signal level, and transmission time are used for detection processing of a DTMF signal as parameters has been described in the above embodiment. However, the present invention is not limited to this and other parameters may be used. In this case, some first parameter is used in the first determination processing of a DTMF signal and a second parameter that is different from the first parameter is used in the second determination processing.

Also, an example in which frequency monitoring is first performed has been described in the above embodiment, but signal level monitoring or transmission time monitoring may first be performed.

Further, an example in which the voice mail module 15 is contained in the main apparatus 1 has been described in the above embodiment, but the voice mail module 15 may be mounted outside the main apparatus 1.

In addition, the configuration and type of system, configuration of the main apparatus, type of extension, detection control procedure of a DTMF signal, and control content thereof may be modified in various ways without deviating from the spirit of the present invention.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A voice mail apparatus connected to a telephone exchange apparatus performing exchange processing among a plurality of telephone terminals to record a voice message sent out from the telephone terminal on a calling side in response to a termination call from the telephone exchange apparatus in a mail box and to reproduce the voice message recorded in the mail box in accordance with reproduction instructions, comprising:
a first determining module which determines whether a dual tone multi frequency (DTMF) signal for identifying a processing request of the voice message is contained in a received signal by detecting and comparing a first parameter of a transmission signal from the mail box and the first parameter of the received signal to the mail box;
a second determining module which determines whether the DTMF signal is contained in the received signal by detecting and comparing a second parameter being different from the first parameter of the transmission signal from the mail box and the second parameter of the received signal to the mail box, when the DTMF signal is not contained in the received signal from a determination result by the first determining module; and
a controller which controls execution/stop of processing of the voice message based on a determination result by the second determining module.

2. The voice mail apparatus of claim 1, wherein the first determining module uses at least one of a frequency, a signal level, and a transmission time of each of the transmission signal and the received signal as the first parameter, and
the second determining module uses at least one of the frequency, signal level, and transmission time of each of the transmission signal and the received signal as the second parameter.

3. The voice mail apparatus of claim 1, wherein the controller reproduces the voice message from the mail box, when the DTMF signal for identifying a reproduction request of the voice message to the mail box is contained in the received signal based on the determination result by the second determining module.

4. The voice mail apparatus of claim 1, wherein the controller stops the voice message reproduced from the mail box, when the DTMF signal for identifying a stop request of the voice message to the mail box is contained in the received signal based on the determination result by the second determining module.

5. A method of controlling a voice mail apparatus connected to a telephone exchange apparatus performing exchange processing among a plurality of telephone terminals to record a voice message sent out from the telephone terminal on a calling side in response to a termination call from the telephone exchange apparatus in a mail box and to reproduce the voice message recorded in the mail box in accordance with reproduction instructions, the method comprising:
determining whether a dual tone multi frequency (DTMF) signal for Identifying a processing request of the voice message is contained in a received signal by comparing a first parameter of a transmission signal from the mail box and the first parameter of the received signal to the mail box;
determining whether the DTMF signal is contained in the received signal by comparing a second parameter being different from the first parameter of the transmission signal from the mail box and the second parameter of the received signal to the mail box, when the DTMF signal is not contained in the received signal based on a determination result by the first parameter; and
controlling execution/stop of processing of the voice message based on a determination result by the second parameter.
